(19) United States
(12) Patent Application Publication
(10) Pub. No.: US 2026/0131894 A1
(43) Pub. Date: May 14, 2026

(54) BLUNTED MODULE CRUCIFORM PARACHUTE

(71) Applicant: Roy L. Fox, JR., Yuma, AZ (US)

(72) Inventor: Roy L. Fox, JR., Yuma, AZ (US)

(21) Appl. No.: 19/388,711

(22) Filed: Nov. 13, 2025

Related U.S. Application Data
(60) Provisional application No. 63/720,336, filed on Nov. 14, 2024.

(51) Int. Cl. B64D 17/02

(52) U.S. Cl. CPC B64D 17/02

(57) ABSTRACT

A cruciform parachute is configured to provide improved packability and/or reduced construction expense. In an exemplary parachute, a first module has a first blunted end, and a second module has a second blunted end coupled to the first blunted end. The first and second modules can be blunted diamond modules. A first joint is located at a first end of the first blunted end. A second joint is located at a second end of the first blunted end. One or more modules having pointed ends can converge at the first joint. One or more other modules having pointed ends can converge at the second joint. Components of the parachute may be two-dimensional in construction in order to reduce construction expense. Components of the parachute may also be modular and/or interchangeable.

### CROSS-REFERENCE TO RELATED APPLICATIONS

This application claims priority to, and the benefit of, U.S. Provisional Patent Application Ser. No. 63/720,336 filed Nov. 14, 2024 entitled “BLUNTED MODULE CRUCIFORM PARACHUTE.” The foregoing application is hereby incorporated by reference in its entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to parachutes, and more particularly to cruciform parachutes.

### BACKGROUND

Parachutes are an integral component of systems used to deliver cargo or loads aerially to remote or inaccessible locations. To deliver a load aerially, the load is furnished with a parachute delivery system and transported to the delivery site by aircraft. Upon reaching the delivery site, the load is released, ejected or dropped from the aircraft. Shortly after release, a parachute is deployed, which is typically attached to the load by suspension lines and other rigging. The deployed parachute decelerates the descending load to a velocity at which the load may land on the ground or water without damage.

Prior parachutes, including prior cruciform-type parachutes, have suffered from various deficiencies, such as excessive manufacturing expense, aerodynamic (i.e., structural) inefficiency, unequal load and/or force distribution within the parachute, cumbersome packability, and/or the like. Therefore, improved cruciform parachutes and related methods of construction and use remain desirable.

In an exemplary embodiment, a cruciform parachute includes a first module having a first blunted end, a second module having a second blunted end coupled to the first blunted end, a first joint located at a first end of the first blunted end, a second joint located at a second end of the first blunted end, a third module having a first pointed end that converges at the first joint, and a fourth module having a second pointed end that converges at the second joint.

In another exemplary embodiment, a cruciform parachute includes a square center module, a first square side module, a second square side module, a first shoulder module coupled to the first square side module and to the square center module, and a second shoulder module coupled to the second square side module and to the square center module. The first square side module can have similar dimensions to the square center module. The second square side module can have similar dimensions to the square center module. The first shoulder module can have a first blunted end. The second shoulder module can have a second blunted end extending along the first blunted end. The square center module can converge at a first joint defined by a first end of the first blunted end. The first square side module can converge at a second joint defined by a second end of the first blunted end. The second square side module can converge at the second joint.

In another exemplary embodiment, a cruciform parachute includes a first plurality of modules converging at a first joint and a second plurality of modules converging at a second joint. The first plurality of modules includes a first module having a first blunted end. The first plurality of modules includes a second module having a second blunted end extending along the first blunted end. The first blunted end and the second blunted end extend between and to the first joint and the second joint.

These and other embodiments may optionally include one or more of the following features.

The first module can be coupled to the third module along a first side of the first module. The first module can be coupled to the fourth module along a second side of the first module.

The first module can be a shoulder module. The second module can be a shoulder module. The third module can be a square center module. The fourth module can be a first square side module.

The cruciform parachute can further include a fifth module having a third pointed end that converges at the second joint. The fifth module can be a second square side module.

The cruciform parachute can further include a sixth module having a fourth pointed end that converges at the second joint. The sixth module can be a corner module located between the fourth module and the fifth module.

The first module can include first opposing sides oriented at a first acute angle. The second module can include second opposing sides oriented at a second acute angle.

The cruciform parachute can further include a strip of material extending from a first side of the first module and defining the first blunted end and the second blunted end, wherein the strip of material extends between and to the first blunted end of the first module and the second blunted end of the first module.

The cruciform parachute can further include a strip of material extending through a center of the first module and defining the blunted end, wherein the strip of material extends between and to a first end of the first module and a second end of the first module.

The first shoulder module can be coupled to the square center module along a first side of the first shoulder module and the first shoulder module can be coupled to the first square side module along a second side of the first shoulder module.

At least one of the first shoulder module or the second shoulder module can be configured in the shape of an isosceles triangle.

The first plurality of modules can include a third module. The first module can be coupled to the third module along a first side of the first module.

The contents of this summary section are provided only as a simplified introduction to the disclosure and are not intended to be used to limit the scope of the appended claims.

### BRIEF DESCRIPTION OF THE DRAWINGS

With reference to the following description, appended claims, and accompanying drawings:

FIG. 1A illustrates components of a cruciform parachute;

FIG. 1B illustrates components of a cruciform parachute wherein side modules may be joined together at the parachute skirt;

FIG. 1C illustrates components of a modified cruciform parachute;

FIG. 2A illustrates exemplary components of a modified cruciform parachute in accordance with an exemplary embodiment;

FIG. 2B illustrates exemplary components of a modified cruciform parachute wherein side modules may be coupled to additional modules disposed therebetween in accordance with an exemplary embodiment;

FIGS. 2C through 2E illustrate exemplary load paths in a modified cruciform parachute in accordance with an exemplary embodiment;

FIG. 3A illustrates exemplary components of a modified cruciform parachute in accordance with an exemplary embodiment;

FIG. 3B illustrates exemplary load paths in a modified cruciform parachute in accordance with an exemplary embodiment;

FIG. 3C illustrates exemplary equalized load paths in a modified cruciform parachute in accordance with an exemplary embodiment;

FIG. 3D illustrates coupling of exemplary components of a modified cruciform parachute to approximate a portion of a hemispherical shape in accordance with an exemplary embodiment;

FIG. 4A illustrates exemplary components of a modified cruciform parachute in accordance with an exemplary embodiment;

FIG. 4B illustrates exemplary configurations of components of a modified cruciform parachute in accordance with an exemplary embodiment;

FIG. 4C illustrates an exemplary modified cruciform parachute in accordance with an exemplary embodiment, illustrated inflated to show a substantially circular skirt;

FIGS. 5A and 5B illustrate exemplary components of a modified cruciform parachute in accordance with an exemplary embodiment;

FIG. 5C illustrates exemplary configurations of components of a modified cruciform parachute in accordance with an exemplary embodiment;

FIG. 5D illustrates exemplary configurations of components of a modified cruciform parachute in accordance with an exemplary embodiment;

FIG. 6A illustrates an exemplary joint of a modified cruciform parachute in accordance with an exemplary embodiment;

FIG. 6B illustrates an exemplary joint of a modified cruciform parachute having two discrete joints separated by blunted ends of adjoining parachute modules in accordance with an exemplary embodiment;

FIG. 7A illustrates an exemplary parachute module having pointed ends in accordance with an exemplary embodiment;

FIGS. 7B through 7D illustrate exemplary methods for modifying the parachute module of FIG. 7A to have blunted ends in accordance with exemplary embodiments; and

FIG. 8 illustrates exemplary modules of a modified cruciform parachute having connections tied together along the edges at discrete locations of the modules in accordance with an exemplary embodiment.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for parachute construction, configuration, reinforcement, deployment, recovery, reefing, disreefing, and/or the like may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical modified cruciform parachute.

For pressure containing vessels, a sphere is more efficient than any other known shape. Spheres, however, typically aren't convenient shapes for transporting material (such as high-pressure gases); as a result, it is common to see the tank of the propane transporting truck or similar constructed from a cylinder with a dome (hemispherical cap) on each end. It will be appreciated that conventional “round” parachutes may be considered to be somewhat akin to a cylinder (the column of air directly under the parachute canopy) and a hemispherical cap (the parachute canopy) because these two components are subjected to more than ambient pressure. The cylinder in this case is very inefficient, leaking air in all directions and causing much of it to spill around the parachute canopy. However, a parachute canopy is much more efficient than the air column and, therefore, the closer the canopy is to being hemispherical, the more structurally efficient it is, when compared to a canopy that has more deviation from hemispherical. Because of inward tension produced by the parachute suspension members, the canopy of a parachute (while generally thought of as being hemispherical) is usually somewhat more than just the northern half of a sphere, with the canopy skirt actually located slightly south of the “equator.” Even parachute canopies constructed as flat discs, typically made from radiating wedge-shaped gores, become generally hemispherical when inflated due to the internal pressure and downward and inward tension of the suspension members. Such flat disc parachutes, known as flat circulars, are relatively strong and relatively inexpensive to construct, but they contain much more fabric than is needed for good performance. If parachute weight and/or volume are of concern, reshaping the radiating gores is typical but, with the gore reshaping comes more design and construction time in addition to more fabric waste.

Prior cruciform parachutes addressed, at least partially, such concerns by reducing design and construction time and fabric waste. Because of its simple shape, a cruciform parachute is more economical to construct than any other parachute type. However, due to the roughly box-like canopy shape, the cruciform parachute isn't nearly as structurally efficient as is a parachute with a generally hemispherical shape.

As used herein, the term “blunted end” refers broadly to an end portion of a parachute module that is non-pointed. A blunted end may be flat, linear, arcuate, curved, faceted, or otherwise shaped such that the end does not terminate at a single sharp point. A blunted end may be defined by a strip of material, an added portion of material, removal of material, or by forming the module with additional width at the end. A blunted end may extend between and to two or more joints, and may separate a location of convergence of multiple modules into two or more discrete joints. A blunted end may maintain the angular orientation of the sides of the module from which it extends, and forming a module with a blunted end may reduce pack-induced entanglements and/or simplify construction. Unless expressly stated otherwise, the term “blunted end” is not limited to any particular geometry, dimensions, fabrication technique, or material.

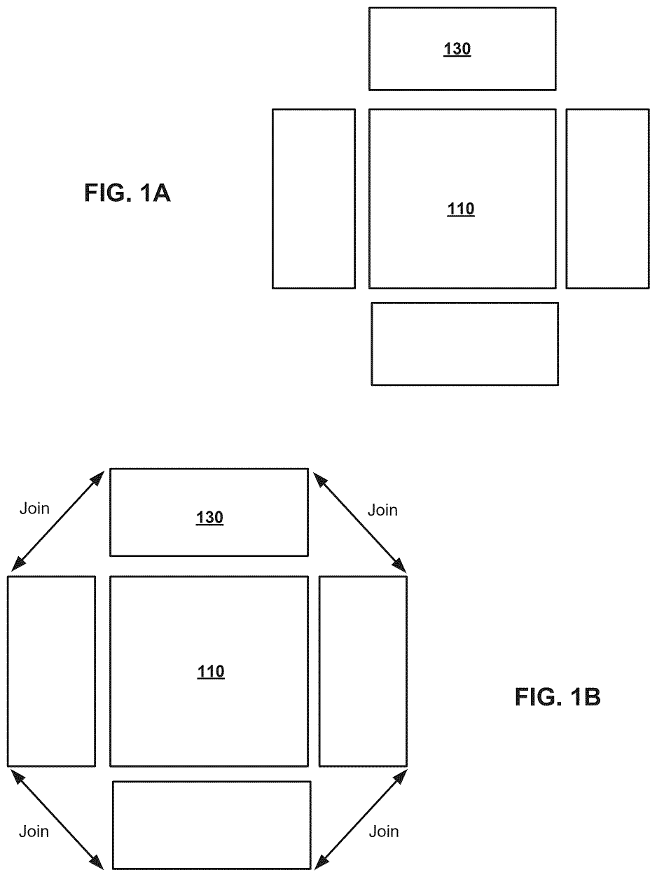

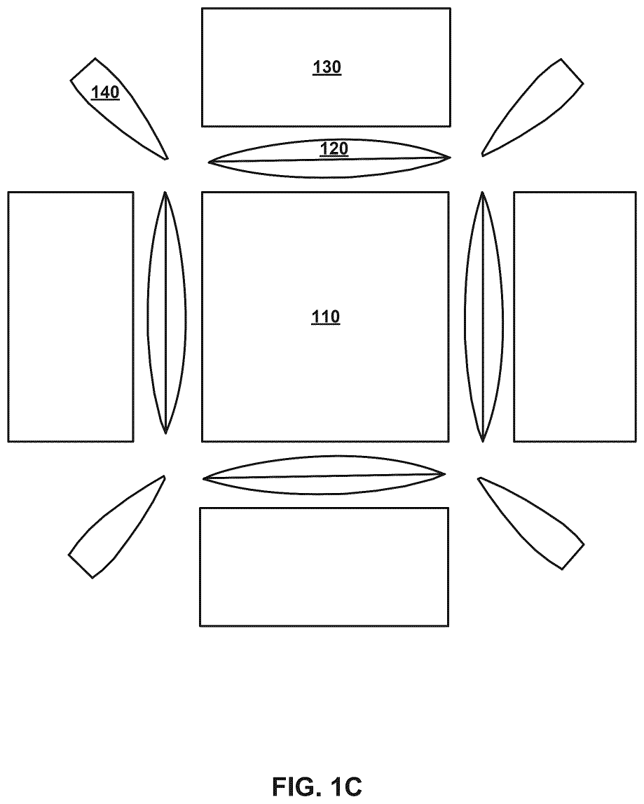

With reference now to FIG. 1A, typical prior simple cruciform (or cross-style) parachute canopies comprised a center module 110 and side modules 130. While center module 110 is typically square, the width to length ratio of the side modules 130 may vary, depending on the desires of the parachute designer. Both center module 110 and side modules 130 may be fabricated from multiple sub-assemblies (e.g., multiples pieces of canopy fabric joined together) and each module may have reinforcements and venting orifices distributed within it. Additionally, the modules may be closely joined, essentially forming a single-piece parachute canopy, or they may be joined only at discrete points, allowing venting between the modules.

Simple cruciform parachutes are relatively economical to fabricate, but they have some disadvantages when compared to certain other types of parachutes. For instance, due to the large, roughly triangular openings between adjacent side modules, it is easy for other portions of the parachute to pass between two side modules during deployment dynamics, which results in an entangled parachute. Another disadvantage of the simple cruciform parachute is that the triangular openings between the adjacent sides can allow the sides to become somewhat propeller-like, causing the parachute to rotate as it descends.

A conventional cruciform parachute canopy (for example, as illustrated in FIG. 1A), which consists of a square center section 110 and four square or rectangular sides 130, was redesigned by Puskas (U.S. Pat. No. 5,839,695) to form a cruciform parachute canopy having a square center section and four trapezoidal (tapered) sides. The Puskas design allowed for venting between the center section and the sides.

Berland (U.S. Pat. No. 6,443,396) chose to partially join side modules 130 together (for example, as illustrated in FIG. 1B) in an attempt to address the deployment entanglement and rotational issues of the typical cruciform parachute. Berland has some advantages over Puskas in that it has a continuous skirt band, which decreases the probability of canopy malfunctions during deployment and inflation. It is also less likely to rotate as it descends. However, the Berland design causes the canopy skirt region to be smaller than the upper portion of the canopy, making for a somewhat inefficient use of the canopy fabric between the square center section and the skirt band.

Fox (U.S. Pat. No. 7,261,258) added flat modules 140 between the side modules 130, and also added 3-dimensional modules 120 between the side modules 130 and the center module 110, for example as illustrated in FIG. 1C. The addition of these flat modules 140 and 3-dimensional modules 120 caused the cruciform parachute canopy to more closely resemble a hemispherical parachute canopy, which allowed it to overcome the entanglement and rotational issues of the typical cruciform parachute, and, due to its improved shape, made it capable of sustaining higher deployment forces than a typical cruciform parachute could sustain. This design permits all modules to be joined with textile tapes or cord, allowing venting between all modules. The hemispherical canopy shape is capable of withstanding opening forces that may be encountered during high-speed deployments. However, module 120 is fabricated as a 3-dimensional part, adding undesirable material and labor costs, for example for parachutes that will only be exposed to relatively low speed deployments.

In various exemplary embodiments, and in accordance with principles of the present disclosure, modified cruciform parachutes overcome various shortcomings of certain prior parachutes. Aerodynamic inefficiency may be reduced. Parachute failure rates at high dynamic pressures may be reduced. Construction costs may be reduced. Parachute construction may be simplified. Additionally, exemplary modified cruciform parachutes, for example modified cruciform parachute 200, 400, 500 and/or 600b, may be configured with improved packability which can mitigate the risk of entanglement of the parachute when deployed.

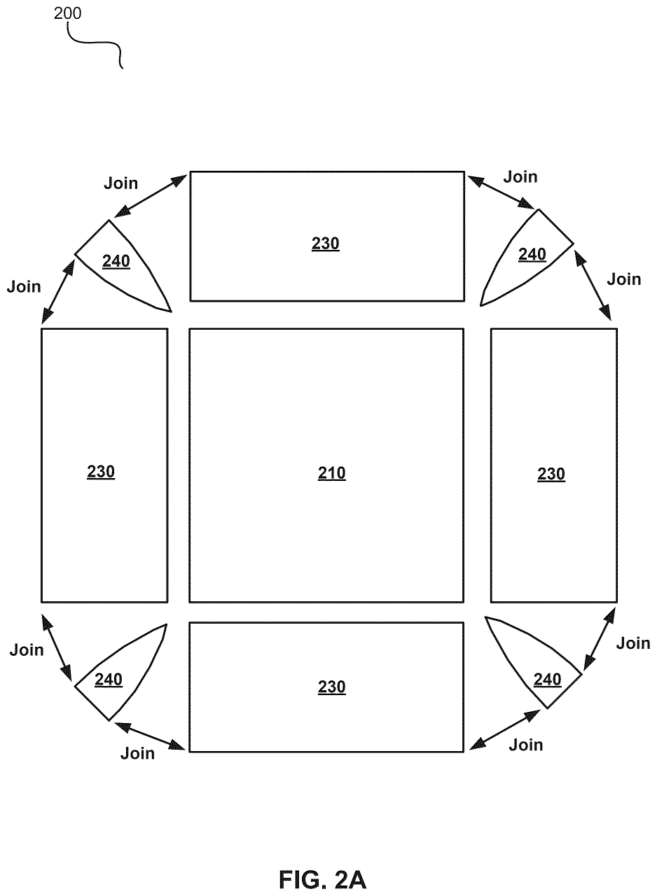

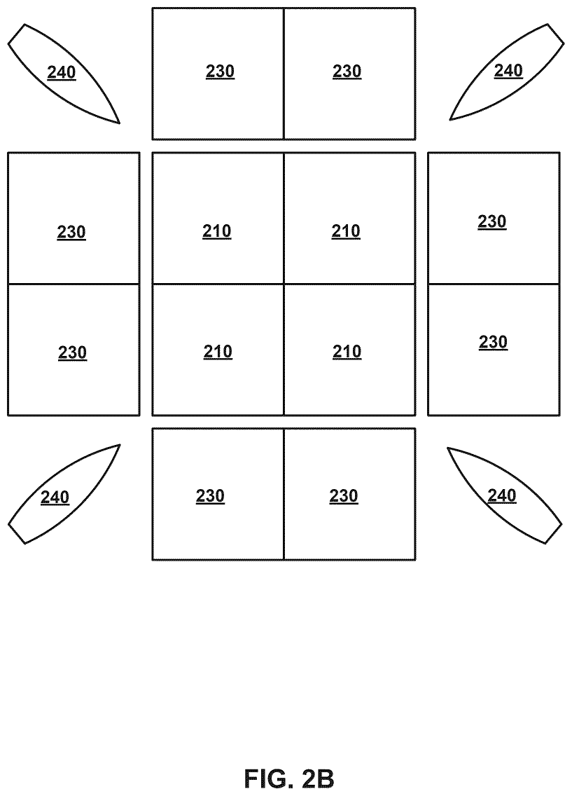

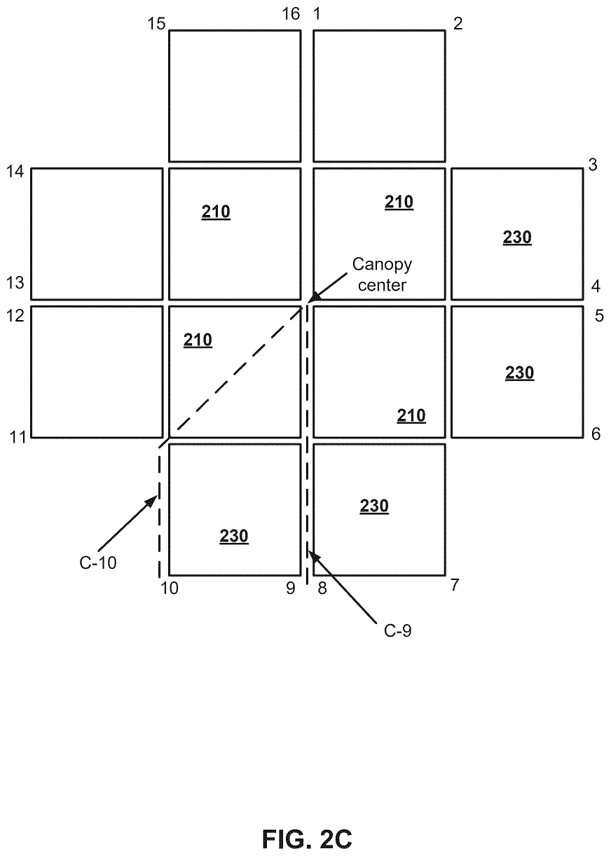

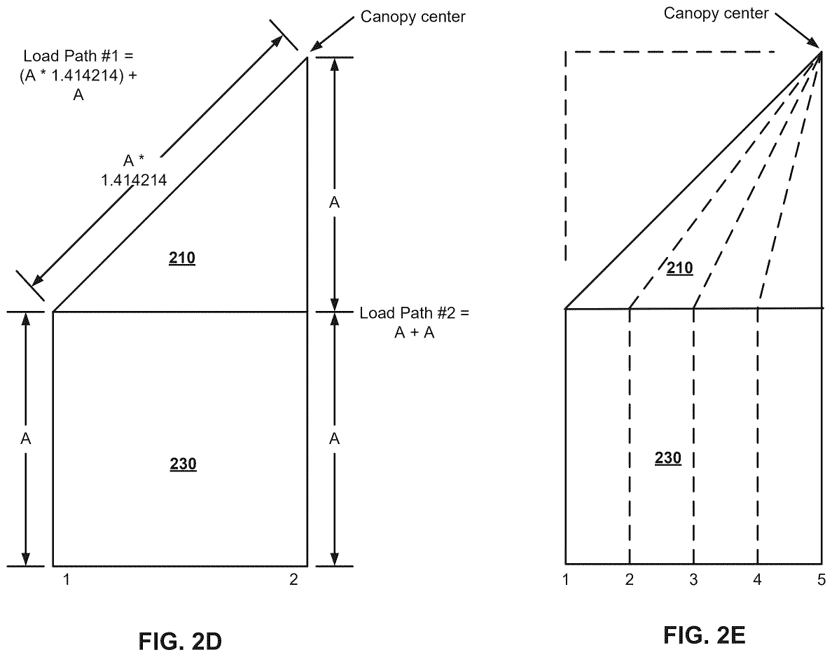

Turning now to FIGS. 2A and 2B, in accordance with an exemplary embodiment a modified cruciform parachute 200 comprises at least one center module 210, a plurality of side modules 230, and a plurality of corner modules 240. Center module 210, side modules 230, and corner modules 240 are coupled together to form a parachute canopy.

Modified cruciform parachute 200 may be configured to be compatible for use with an inlet parachute reefing device, for example as disclosed in U.S. Pat. No. 8,096,509 to Fox, the contents of which are incorporated herein by reference in their entirety.

In various exemplary embodiments, center module 210 comprises a suitable material, for example a textile and/or film, such as nylon, mylar, and/or the like. Center module 210 may be square, rectilinear, pentagonal, hexagonal, and/or the like, as desired. Center module 210 may be monolithic; alternatively, center module 210 may be comprised of sub-modules. Stated another way, center module 210 may be comprised of multiple center modules 210. For example, as illustrated in FIG. 2B, in an exemplary embodiment the center portion of the parachute canopy comprises four center modules 210. These combined modules may be considered to be a center module 210. When multiple center modules 210 are utilized in modified cruciform parachute 200, venting may be provided therein and/or therebetween. Center modules 210 may be joined to one another and/or to other components of modified cruciform parachute 200 via any suitable means, for example via stitching, taping, lacing, gluing, and/or the like.

In various exemplary embodiments, center module 210 may be similarly sized and/or identical to other modules in modified cruciform parachute 200, for example side module 230. In this manner, manufacturing costs may be reduced, and assembly and/or repair of modified cruciform parachute 200 may be simplified, because components may be interchangeable.

In an exemplary embodiment, modified cruciform parachute 200 comprises four center modules 210. In another exemplary embodiment, modified cruciform parachute 200 comprises nine center modules 210. In yet another exemplary embodiment, modified cruciform parachute 200 comprises sixteen center modules 210. Any suitable number and/or size of center modules 210 may be utilized, for example in order to achieve a desired configuration of modified cruciform parachute 200.

In various exemplary embodiments, modified cruciform parachute 200 comprises a plurality of side modules 230. Side module 230 comprises a suitable material, for example a textile and/or film, such as nylon, mylar, and/or the like. In modified cruciform parachute 200, side module 230 may comprise a similar material to other modules, for example center module 210; moreover, side module 230 may comprise different materials than other modules, for example in order to achieve a desired strength, flexibility, and/or the like. Side module 230 may be square, rectilinear, trapezoidal, and/or the like, as desired. Side module 230 may be monolithic; alternatively, side module 230 may be comprised of sub-assemblies. Stated another way, side module 230 may be comprised of multiple side modules 230. For example, as illustrated in FIG. 2B, in an exemplary embodiment each side portion of the parachute canopy comprises two square side modules 230. These combined modules may be considered to be a rectangular side module 230. When multiple side modules 230 are utilized in modified cruciform parachute 200, venting may be provided therein and/or therebetween. Side modules 230 may be joined to one another and/or to other components of modified cruciform parachute 200 via any suitable means, for example via stitching, taping, lacing, gluing, and/or the like.

In various exemplary embodiments, side module 230 may be similarly sized and/or identical to other modules in modified cruciform parachute 200, for example center module 210. In this manner, manufacturing costs may be reduced, and assembly and/or repair of modified cruciform parachute 200 may be simplified.

In an exemplary embodiment, modified cruciform parachute 200 comprises four side modules 230, with one disposed on each side of center module 210. In another exemplary embodiment, modified cruciform parachute 200 comprises eight side modules 230, with two disposed on each side of center module 210 (for example, as illustrated in FIG. 2B). In yet another exemplary embodiment, modified cruciform parachute 200 comprises twelve side modules 230. Any suitable number and/or size of side modules 230 may be utilized, for example in order to achieve a desired configuration of modified cruciform parachute 200.

In various exemplary embodiments, modified cruciform parachute 200 comprises a plurality of corner modules 240. Corner module 240 is configured to allow modified cruciform parachute 200 to more closely resemble a hemispherical parachute when deployed, improving aerodynamic efficiency. Additionally, corner module 240 may be configured to facilitate reefing of modified cruciform parachute 200.

In various exemplary embodiments, corner module 240 comprises a suitable material, for example a textile and/or film, such as nylon, mylar, and/or the like. In modified cruciform parachute 200, corner module 240 may comprise a similar material to other modules; moreover, corner module 240 may comprise different materials than other modules, for example in order to achieve a desired strength, flexibility, and/or the like. Corner module 240 may be tapered, triangular, curvilinear, and/or the like, as suitable, in order to achieve a desired inflated configuration of modified cruciform parachute 200. Corner module 240 may be monolithic; alternatively, corner module 240 may be comprised of sub-assemblies. Stated another way, corner module 240 may be comprised of multiple corner modules 240. For example, in an exemplary embodiment two triangular corner modules 240 may be disposed adjacent to one another and coupled together to form a larger, triangular-shaped corner module 240. These combined modules may be considered to be a corner module 240. When corner modules 240 are utilized in modified cruciform parachute 200, venting may be provided therein, therebetween, and/or between corner modules 240 and other components of modified cruciform parachute 200, for example between a corner module 240 and a side module 230. Corner modules 240 may be joined to one another and/or to other components of modified cruciform parachute 200 via any suitable means, for example via stitching, taping, lacing, gluing, and/or the like.

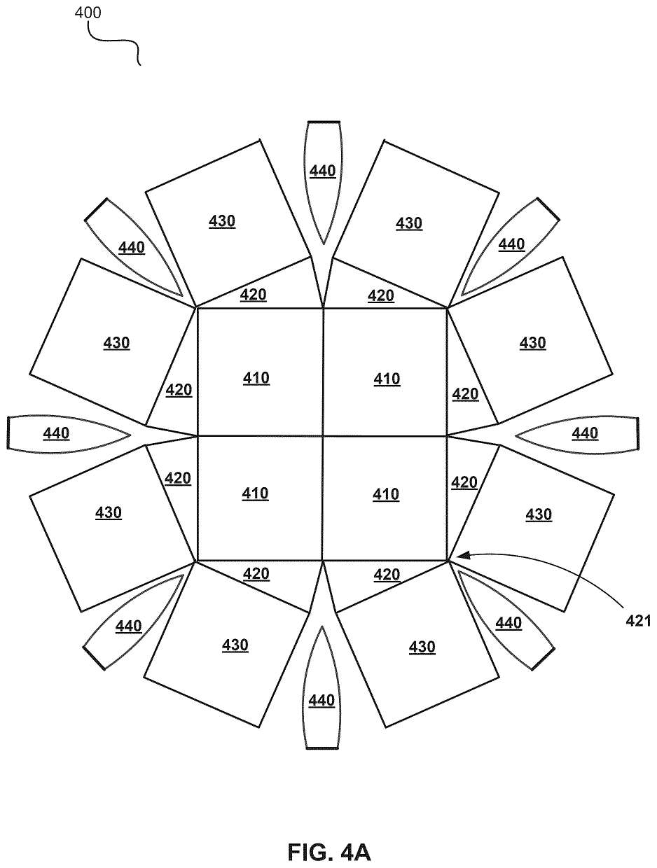

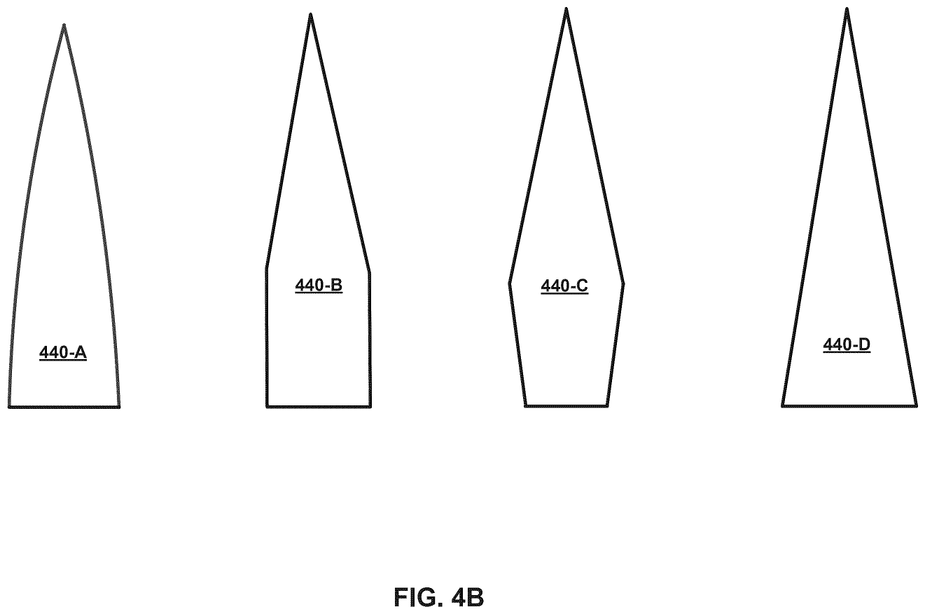

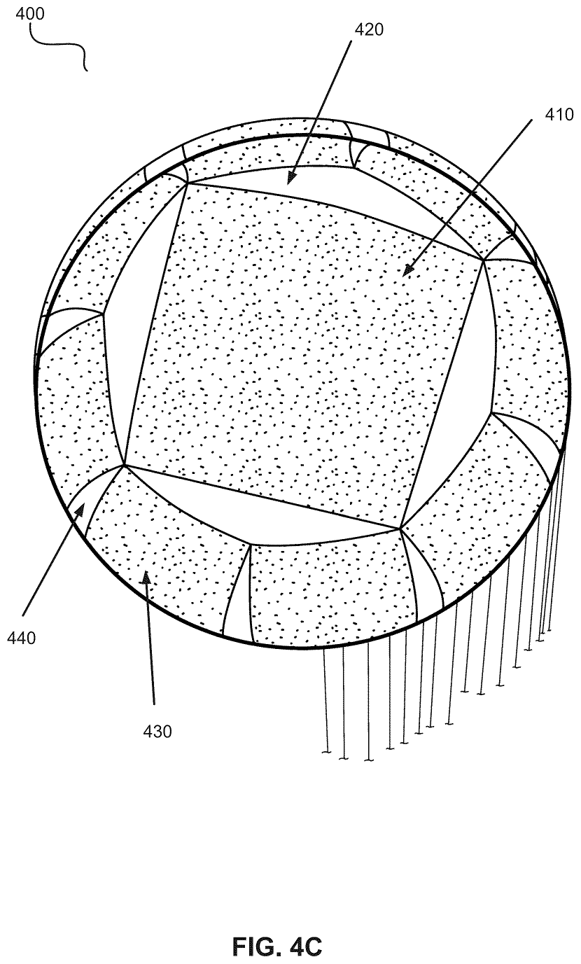

In an exemplary embodiment, for example as illustrated in FIGS. 2A and 2B, modified cruciform parachute 200 comprises four corner modules 240, with one corner module 240 disposed at each “corner” of the parachute canopy (i.e., approximately at 45, 135, 225, and 315 degrees). In another exemplary embodiment, modified cruciform parachute 200 comprises four corner modules 240, with one corner module 240 disposed at approximately 0, 90, 180, and 270 degrees on the parachute canopy. In yet other exemplary embodiments, with momentary reference to FIG. 4A, an exemplary modified cruciform parachute (for example, modified cruciform parachute 400) may comprise eight corner modules (for example, corner modules 440) spaced approximately equally about the canopy perimeter.

Moreover, modified cruciform parachute 200 may comprise any suitable number of corner modules 240, and such corner modules 240 may be disposed at any compass location around the canopy perimeter, in order to achieve a desired configuration of modified cruciform parachute 200.

With reference now to FIGS. 2A, 2B, 3A, 4A, and 5A in various exemplary embodiments, a modified cruciform parachute (for example, modified cruciform parachute 200, 300, 400, and/or 500) is configured with one or more corner modules. By utilizing corner modules, a modified cruciform parachute configured in accordance with principles of the present disclosure is configured to reduce canopy entanglements and increase the effective drag area of the parachute.

In prior cruciform parachutes, there is an opening, a gap, between adjacent sides of typical cruciform parachute canopies, and the shape of that gap is primarily affected by two forces. One of those forces is internal positive pressure that results from the parachute being pulled through the atmosphere. This internal pressure tends to push the lower region of the parachute canopy outward, relative to the parachute longitudinal centerline. The other force is the tendency for the suspension members, which converge at a single point beneath the parachute canopy, to pull the lower region of the parachute canopy inward, toward the parachute's longitudinal centerline. With the parachute moving through the atmosphere at a steady rate, the outward positive pressure and the inward pull of the suspension members will reach a general state of equilibrium. When that occurs, the gap between the canopy sides will assume a specific shape in accordance with the ratio of outward force to inward force. Rate of movement through the atmosphere will affect the internal pressure of the canopy and, therefore, the amount of outward force. The length of suspension members will affect inward force, with short suspension members causing more inward force than do long suspension members. However, other forces, such as air turbulence, can momentarily alter the balance between the inward and outward forces and, therefore, momentarily affect the precise shape of the gap between adjacent canopy sides.

Regardless of the precise shape of the opening between canopy sides, the large openings are undesirable because they can lead to entanglements during the somewhat chaotic parachute deployment phase, and they can cause the parachute canopy to become somewhat rotor-like, causing the canopy to spin. Some prior parachute designers, such as the Puskas and Berland references discussed hereinabove, chose to simply join adjacent sides to one another and eliminate the gap. While the technique of closing the gap between adjacent sides by just securing the sides together reduces entanglements, it also has disadvantages, mainly that of reducing the circumference of the parachute canopy and, therefore, its effective drag area.

In contrast, in accordance with principles of the present disclosure, modified cruciform parachutes are configured with a plurality of corner modules (for example, corner module 240, 340, 440 and/or 540). In various exemplary embodiments, a corner module, for example corner module 240, is configured with a shape resembling a truncated vesica piscis, with a selected width-to-height ratio influenced at least in part by the ratio of inward and outward forces anticipated to be acting on the parachute canopy.

In contrast to prior approaches that eliminated the gap between parachute sides by joining the sides, corner module 240 eliminates the disadvantages of a gap between adjacent sides and, beneficially, does not reduce the canopy's effective drag area; rather, via use of corner module 240, modified cruciform parachute 200 achieves increased effective drag area. It will be appreciated that a variety of shapes may be utilized for corner module 240 (and/or corner modules 340, 440 and/or 540). In various exemplary embodiments, corner module 240 is configured as a truncated vesica piscis in order to maximize the effective drag area of modified cruciform parachute 200. In certain exemplary embodiments, above the widest portion of corner module 240, corner module 240 is configured with an arc having a radius between about the width of center module 210 and the diagonal dimension of center module 210. In these exemplary embodiments, below the widest portion of corner module 240, corner module 240 is configured with an arc having a radius up to about 15% smaller than the radius of the arc above the widest portion of corner module 240.

With reference now to FIG. 2C, force distribution in a cruciform parachute is illustrated. It is known that simple cruciform parachutes are not as efficient at force distribution as radiating gore parachutes. Even though cruciform parachute canopies have no true radial structural members, the force distribution within the canopy becomes radial because the suspension members of the parachute converge at a single point (beneath the canopy center). Force is thus distributed to discrete points around the canopy skirt (for example, illustrated as locations 1-16 in FIG. 2C).

In the example cruciform parachute illustrated in FIG. 2C, the canopy is divided into eight equally loaded segments, with each segment consisting of a triangular portion of a center module 210 and a corresponding side module 230. Each segment has two load paths from the skirt to the canopy center. However, the load paths are not of equal length; consequently, the shorter paths are more heavily loaded than the longer paths. For example, load path C-9 (extending from the canopy center to location 9) is shorter than load path C-10 (extending from the canopy center to location 10), even though both load path C-9 and C-10 are associated with a common parachute segment. This unequal distribution of load forces is undesirable, particularly during initial parachute inflation when aerodynamic forces are highest. It will be appreciated that unequal load distribution causes some parts of a parachute canopy to experience higher forces than other parts and, therefore, the parts exposed to the higher forces become more susceptible to failure than do other parts. Unfortunately, failures in one part of a canopy can force other parts of the canopy to face unplanned forces, which can lead to progressive failures.

Turning now to FIGS. 2D and 2E, differences in load path length are illustrated. FIG. 2D illustrates the length difference arising when a load path travels diagonally across center module 210. FIG. 2E illustrates a series of five load paths, as if five suspension lines were attached to the illustrated parachute segment. The load path from canopy center to location 1 is the longest; the load path from canopy center to location 5 is the shortest. Consequently, each of these load paths are exposed to differing forces during parachute operation, with load path 1 being exposed to far less load than load path 5. This unequal distribution of load forces is undesirable, particularly during initial parachute inflation when aerodynamic forces are highest.

Accordingly, principles of the present disclosure contemplate modified cruciform parachutes having load paths of equal lengths (and/or load paths having reduced differences in length), in order to more equally distribute forces within the parachute. In various exemplary embodiments, modified cruciform parachutes configured in accordance with principles of the present disclosure utilize shoulder modules, for example in order to reduce and/or eliminate differences in load path lengths.

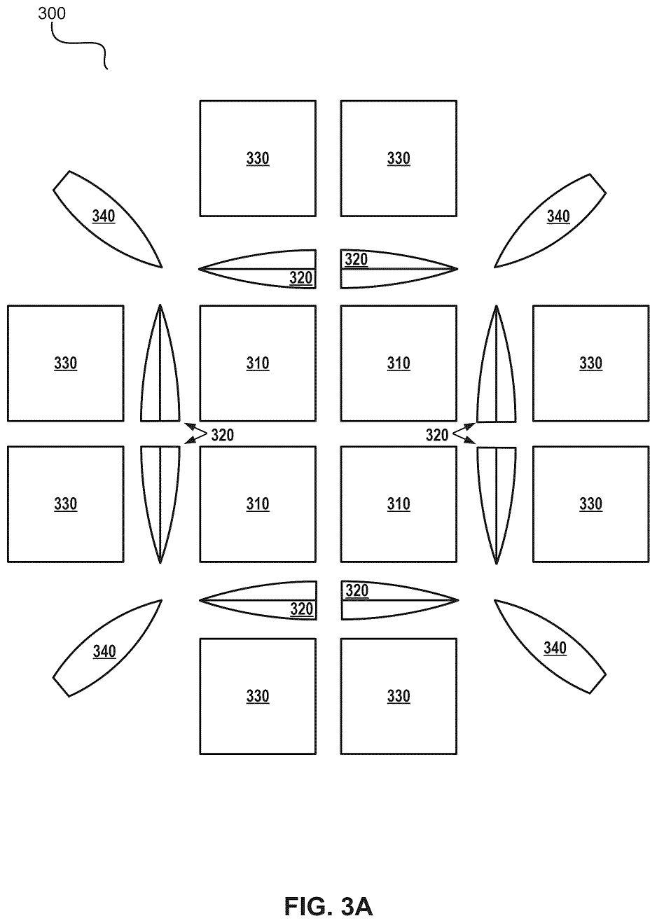

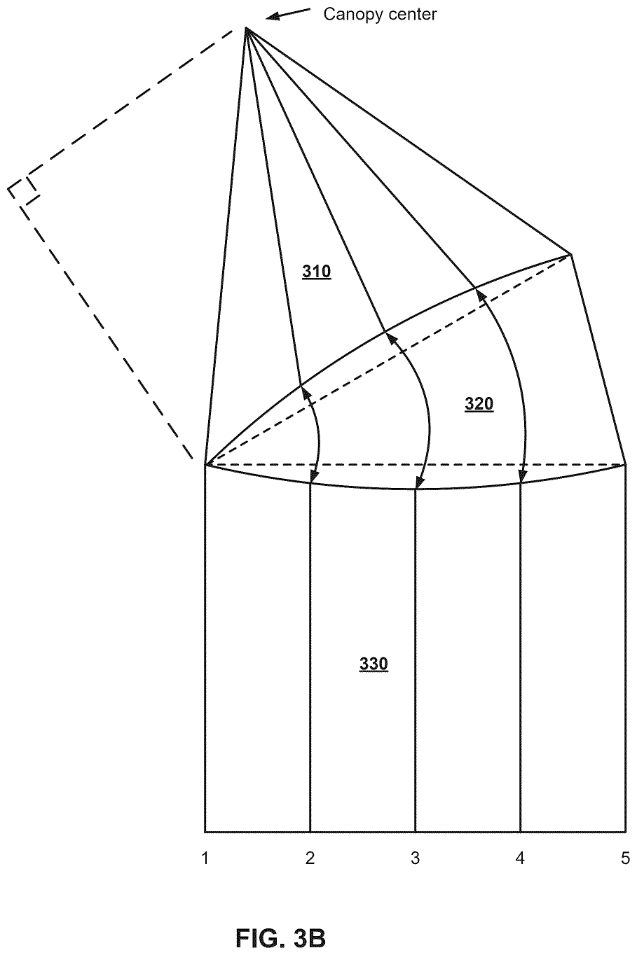

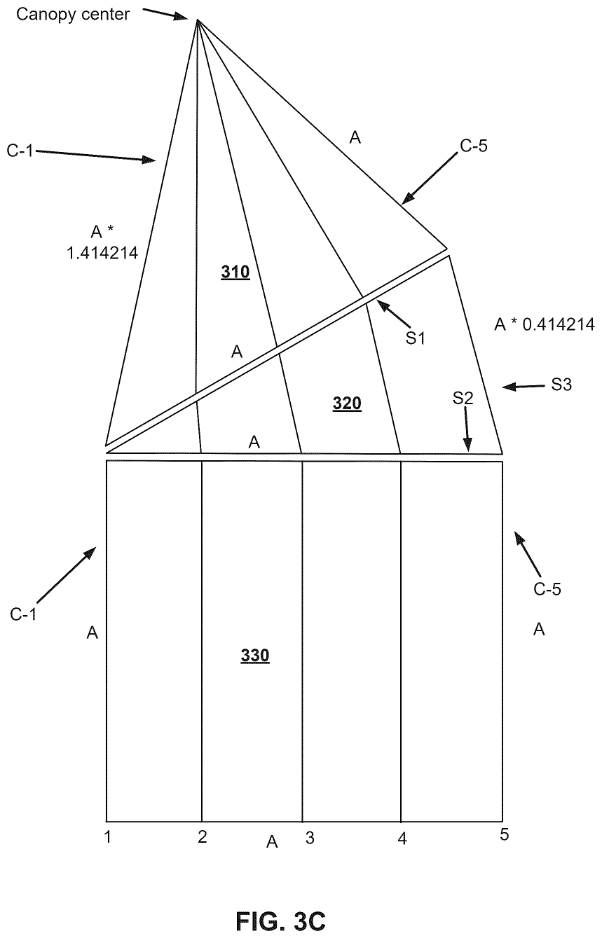

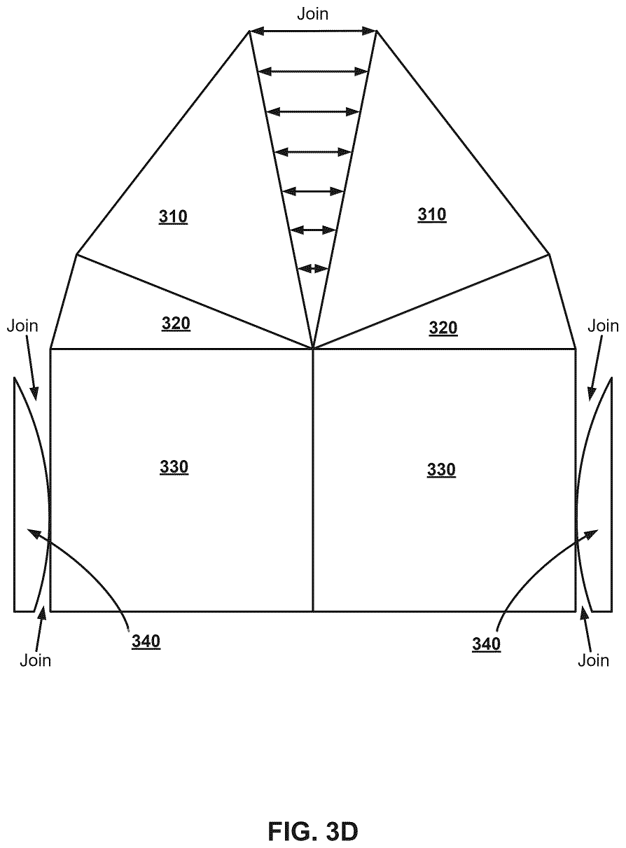

Turning now to FIGS. 3A through 3D, in various exemplary embodiments a modified cruciform parachute 300 is configured with a center module 310, side modules 330, corner modules 340, and with a plurality of shoulder modules 320. Shoulder modules 320 may be configured to equalize (or reduce inequality between) load lengths in modified cruciform parachute 300. Shoulder module 320 comprises a suitable material, for example a textile and/or film, such as nylon, mylar, and/or the like. In modified cruciform parachute 300, shoulder module 320 may comprise a similar material to other modules, for example center module 310; moreover, shoulder module 320 may comprise different materials than other modules, for example in order to achieve a desired strength, flexibility, and/or the like. Shoulder module 320 may be triangular, tapered, and/or the like, as desired. Shoulder module 320 may be monolithic; alternatively, shoulder module 320 may be comprised of sub-assemblies. Stated another way, shoulder module 320 may be comprised of multiple shoulder modules 320.

In contrast to prior approaches that utilized three-dimensional portions to link center modules and side modules, in modified cruciform parachute 300, shoulder modules 320 are flat (i.e., two-dimensional). Because shoulder modules 320 are flat, construction costs and complexity are significantly reduced. Additionally, as compared to prior three-dimensional portions, shoulder modules 320 allow modified cruciform parachute 300 to assume a more hemispherical shape when inflated as compared to prior cruciform parachutes. Yet further, in various exemplary embodiments, modified cruciform parachute 300 is configured to achieve an inflated diameter that is approximately equal to the constructed diameter. In this manner, modified cruciform parachute 300 achieves improved force distribution and aerodynamic efficiency while utilizing less complex component shapes.

In modified cruciform parachute 300, when center module 310 and side module 330 are each configured as squares having length A, shoulder module 320 may be configured as an isosceles triangle having two sides of length A and a third side of length 0.414214*A (i.e., a third side of length (√2−1)*A). When center module 310, shoulder module 320, and side module 330 are coupled together as illustrated, it can be seen that load path C-1 (from the canopy center to location 1) has a length of 1.414214*A (traversing center module 310)+A (traversing side module 330)=2.414214 A. At the other side of side module 330, load path C-5 (from the canopy center to location 5) has a length of A (traversing center module 310)+0.414214*A (traversing shoulder module 320)+A (traversing side module 330)=2.414214 A. Load paths C-2, C-3, and C-4 are also configured with the same length of 2.414214 A. By providing equal load path lengths in modified cruciform parachute 300, shoulder module 320 allows for more even force distribution in modified cruciform parachute 300 and consequently, reduced parachute failure.

In various exemplary embodiments, shoulder module 320 is configured as an isosceles triangle; the sides of equal length (S1 and S2) are coupled to center module 310 and side module 330, respectively. In an exemplary embodiment, the remaining side S3 is configured with a length of ((√2−1)*the length of S1 or S2). In various exemplary embodiments, the remaining side S3 is configured with a length of between ((√2−1)*2*the length of S1 or S2) and ((√2−1)*0*the length of S1 or S2). Stated another way, side S3 may be configured with a length +/−100% of ((√2−1)*the length of S1 or S2). In this manner, the dimensions of shoulder module 320 may be varied in order to achieve one or more desired characteristics of modified cruciform parachute 300, for example aerodynamic efficiency under particular loading conditions, construction expense, and/or the like. In various other embodiments, shoulder module 320 may be omitted from modified cruciform parachute 300, (i.e., when side S3 is selected to have zero length).

In various exemplary embodiments, modified cruciform parachute 300 is configured as a modular design. Stated another way, various elements of modified cruciform parachute 300 may be equivalent and/or interchangeable (for example, center module 310 and side module 330), allowing modified cruciform parachute 300 to be created and/or repaired using preformed modules.

In various exemplary embodiments, modified cruciform parachute 300 is constructed via complete joining of the component modules along the corresponding edges. In other exemplary embodiments, modified cruciform parachute 300 is constructed by joining the component modules only at discrete points. In yet other exemplary embodiments, modified cruciform parachute 300 is constructed via complete joining of certain modules, and partial joining of certain other modules. In this manner, the geometric porosity of modified cruciform parachute 300 may be adjusted to the needs of a particular application. For example, a fully joined embodiment may be suitable for instances of low dynamic pressure, while a discretely joined embodiment may be suitable for instances of high dynamic pressure.

Additionally, in certain exemplary embodiments modified cruciform parachute 300 is at least partially configured with (i) joining means (i.e., ties, stitching, and/or the like) that are sufficiently strong to stay intact at high dynamic pressure (i.e., intended to be non-frangible), and/or (ii) joining means (i.e., ties, stitching, and/or the like) that are frangible at high dynamic pressure. The non-frangible joining means and/or the frangible joining means may also be elastic, as desired. In this manner, modified cruciform parachute 300 may be configured to be “self-adjustable”; the canopy would be of low geometric porosity when exposed to low dynamic pressure, preventing most ingested air from passing through and thus decreasing inflation time. However, if sufficiently high dynamic pressure is encountered by modified cruciform parachute 300, one or more of the frangible joining means would fail (and/or the frangible or non-frangible joining means may stretch), thus increasing the geometric porosity, allowing a controlled amount of ingested air to pass through the canopy, and increasing the inflation time. In this manner, modified cruciform parachute 300 may adapt to relieve canopy stress and decrease canopy damage that might otherwise occur at high dynamic pressure.

Turning now to FIGS. 4A and 4B, in various exemplary embodiments a cruciform parachute, for example modified cruciform parachute 400, may be configured to more closely resemble a hemispherical shape when inflated. In an exemplary embodiment, modified cruciform parachute 400 comprises four center modules 410 and eight side modules 430, with a shoulder module 420 disposed between corresponding center modules 410 and side modules 430 as illustrated in FIG. 4A. Additionally, in this exemplary embodiment modified cruciform parachute 400 is configured with eight corner modules 440, for example disposed approximately every 45 degrees about the canopy edge. In various exemplary embodiments, and with reference to FIG. 4B, corner modules 440 may be tapered (i.e., having a shape similar to a truncated vesica piscis, similar to corner module 440-A), pointed (i.e., shaped like a triangle mated to a square or rectangle, similar to corner module 440-B, or shaped like a triangle mated to a trapezoid, similar to corner module 440-C), triangular (i.e., similar to corner module 440-D), and/or combinations of the same. In various exemplary embodiments, in modified cruciform parachute 400, every module comprises a flat (i.e., two-dimensional) piece of material. In various exemplary embodiments, modified cruciform parachute 400 may be configured with additional and/or fewer center modules 410, side modules 430, shoulder modules 420, and/or corner modules 440.

With momentary reference now to FIG. 4C, in various exemplary embodiments a modified cruciform parachute 400 is illustrated in an airstream, showing that the skirt of modified cruciform parachute 400 may be configured to be substantially circular via use of shoulder modules 420 and corner modules 440. In FIG. 4C, for clarity of illustration it will be appreciated that only a subset of the suspension lines for modified cruciform parachute 400 are shown, and that in actuality modified cruciform parachute 400 is usable in connection with suspension lines distributed along the entire parachute skirt.

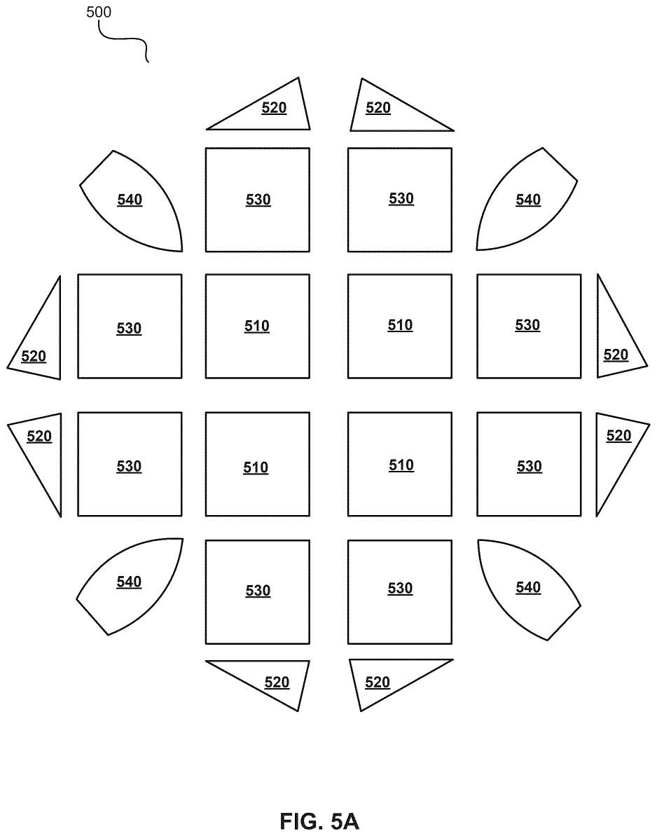

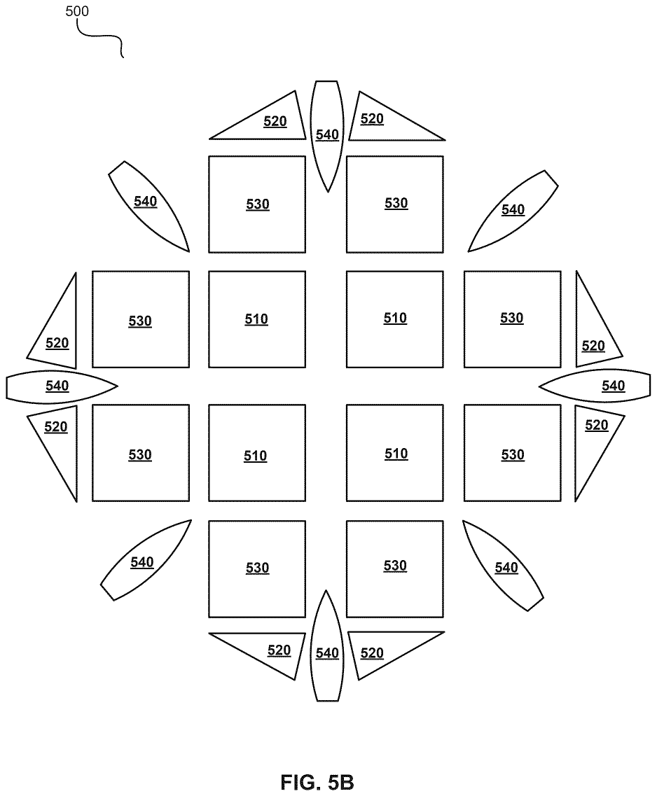

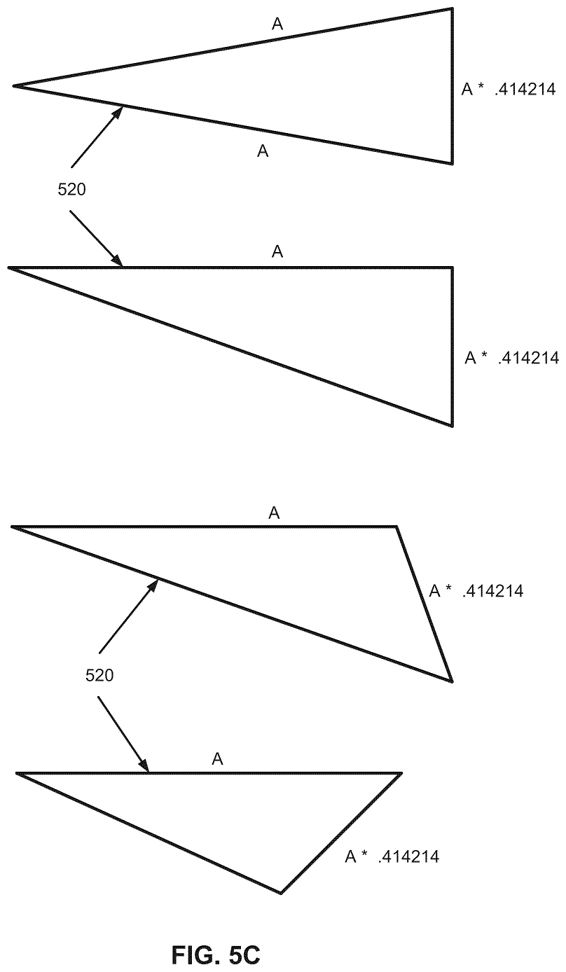

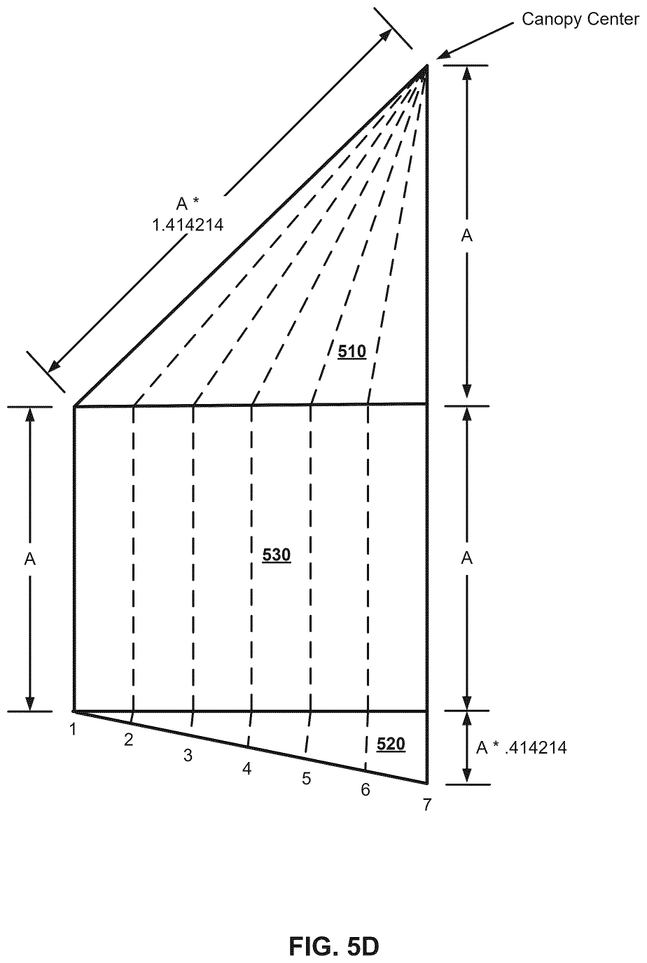

With reference now to FIGS. 5A through 5D, in various exemplary embodiments a modified cruciform parachute 500 is configured with center modules 510, side modules 530, corner modules 540, and with a plurality of peripheral modules 520. Center modules 510 may be identical to side modules 530, as previously disclosed. Moreover, as compared to shoulder modules 320, which are disposed between center modules 310 and side modules 330, peripheral modules 520 are disposed adjacent to side modules 530 on the side opposite center modules 510. Peripheral modules 520 form at least a portion of the skirt of modified cruciform parachute 500. Peripheral modules 520 may be configured to equalize (or reduce inequality between) load lengths in modified cruciform parachute 500.

Peripheral module 520 comprises a suitable material, for example a textile and/or film, such as nylon, mylar, and/or the like. In modified cruciform parachute 500, peripheral modules 520 may comprise a similar material to other modules, for example center module 510; moreover, peripheral module 520 may comprise different materials than other modules, for example in order to achieve a desired strength, flexibility, and/or the like. Peripheral module 520 may be triangular, tapered, and/or the like, as desired. Peripheral module 520 may be monolithic; alternatively, peripheral module 520 may be comprised of sub-assemblies. Stated another way, peripheral module 520 may be comprised of multiple peripheral modules 520.

In various exemplary embodiments, in modified cruciform parachute 500, peripheral modules 520 are flat (i.e., two-dimensional). Because peripheral modules 520 are flat, construction costs and complexity are significantly reduced. Additionally, peripheral modules 520 allow modified cruciform parachute 500 to assume a more hemispherical shape when inflated as compared to prior cruciform parachutes lacking peripheral modules. Yet further, in various exemplary embodiments, modified cruciform parachute 500 is configured to achieve an inflated diameter that is approximately equal to the constructed diameter. In this manner, modified cruciform parachute 500 achieves improved force distribution and aerodynamic efficiency while utilizing less complex component shapes.

In modified cruciform parachute 500, when center module 510 and side module 530 are each configured as squares having length A, peripheral module 520 may be configured as a right triangle having one side of length A and a second side of length 0.414214*A (i.e., a second side of length (√2−1)*A). When center module 510, side module 530, and peripheral module 520 are coupled together as illustrated in FIG. 5D, it can be seen that load path L-1 (from the canopy center to location 1) has a length of 1.414214*A (traversing center module 510)+A (traversing side module 530)=2.414214 A. At the other side of side module 530, load path L-7 (from the canopy center to location 7) has a length of A (traversing center module 510)+A (traversing side module 530)+0.414214*A (traversing peripheral module 520)=2.414214 A. Load paths L-2 through L-6 are also configured with the same length of 2.414214 A. By providing equal load path lengths in modified cruciform parachute 500, peripheral module 520 allows for more even force distribution in modified cruciform parachute 500 and consequently, reduced parachute failure.

With reference now to FIG. 5C, in various exemplary embodiments peripheral module 520 is configured as an isosceles triangle, a right triangle, an obtuse scalene triangle, or an acute scalene triangle. The shape of peripheral module 520 may be configured to equalize (or reduce inequality between) load paths in modified cruciform parachute 500. The shape of peripheral module 520 may also be configured to cause modified cruciform parachute 500 to achieve a more hemispherical shape when inflated, increasing aerodynamic efficiency.

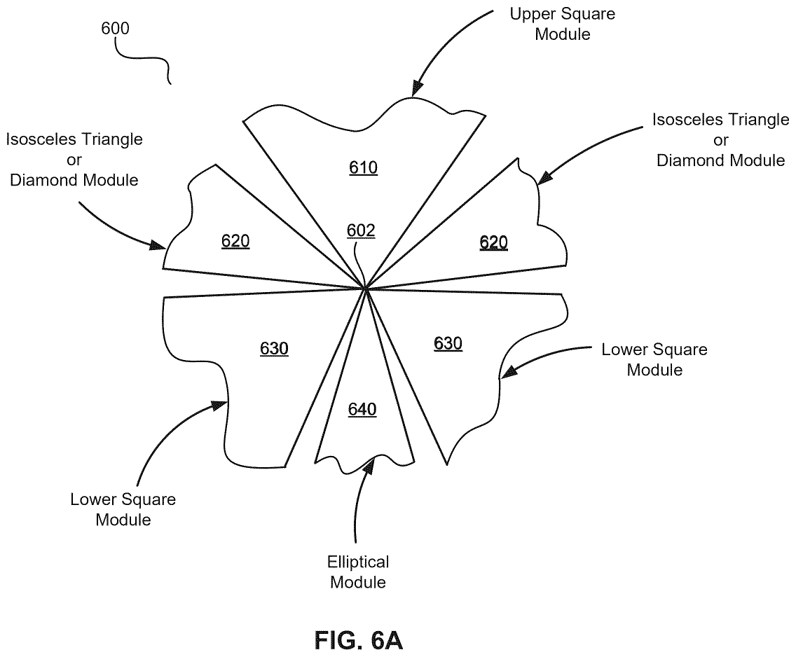

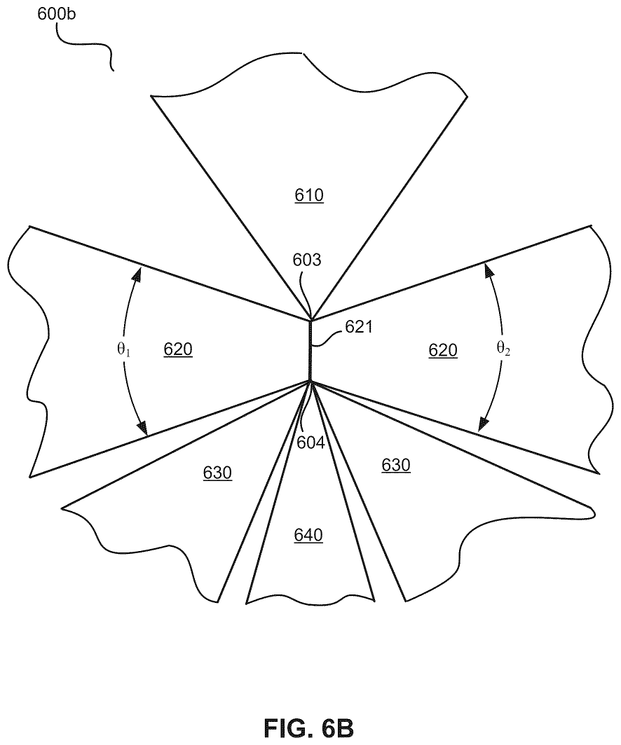

Turning now to FIGS. 6A through 6E, in various exemplary embodiments, various aspects of parachute construction are provided. More particularly, principles of the present disclosure contemplate packability of parachutes that have multiple modules that converge at a single joint. When neatly packed, parachutes with multiple modules that converge at a single joint can perform as desired. However, parachutes with multiple modules that converge at a single joint can be cumbersome to pack and/or construct. Moreover, parachute packers do not always pack parachutes perfectly. Sharply pointed modules (e.g., see FIG. 6A) can be more difficult to pack neatly than are blunted modules. Sharply pointed modules can be more likely to entangle than are blunted modules. Aspects of the present disclosure provide modules with blunted ends to separate the junction into two separate joints (e.g., see FIG. 6B) which tends to be easier to construct and less likely to tangle than is a single joint.

With reference now to FIG. 6A, a cruciform parachute 600 having sharply pointed modules that converge at a single joint 602 is provided, in accordance with various embodiments. It should be understood that only a portion of the cruciform parachute 600 is shown in FIG. 6A (e.g., a zoomed in view of a joint similar to the joint 421 of FIG. 4A) and the cruciform parachute 600 depicted in FIG. 6A can be constructed via joining of the component modules along the corresponding edges. Parachute 600 can be similar to the parachute 400 of FIG. 4A in various embodiments. A center module 610, two side modules 630, two shoulder modules 620, and a corner module 640 can converge at the joint 602. Although illustrated as the center module 610, two side modules 630, two shoulder modules 620, and the corner module 640, it should be understood that any number or type of parachute modules can converge at the joint 602.

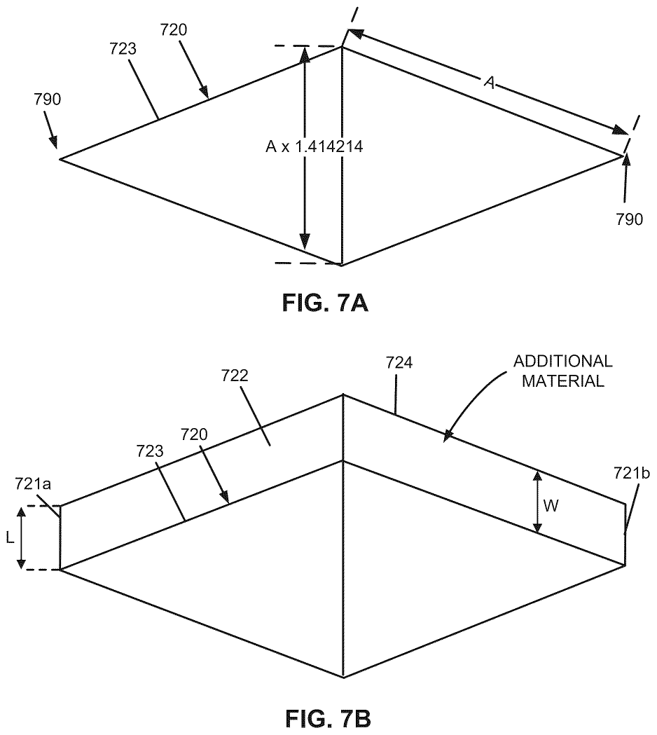

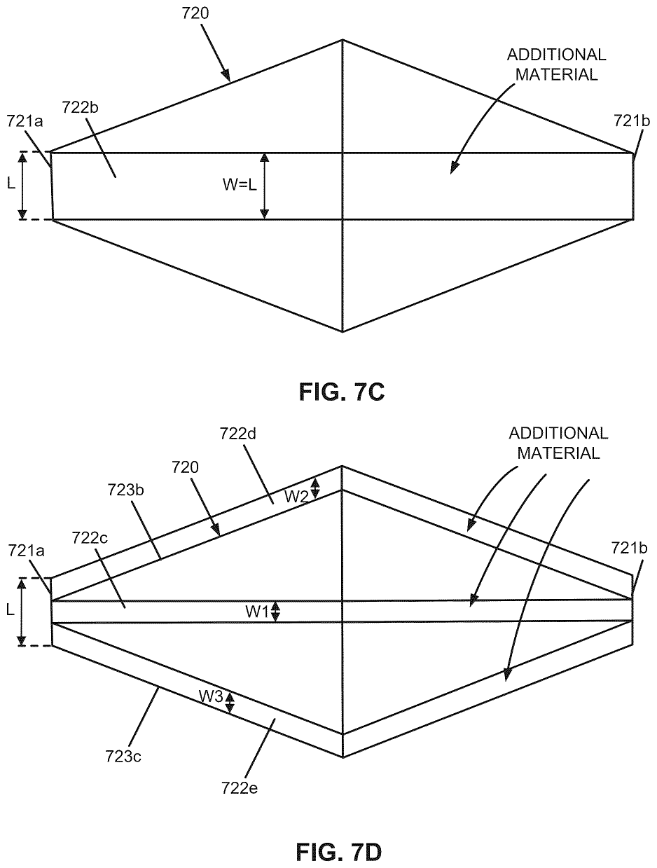

With reference now to FIG. 6B, a cruciform parachute 600b having two blunted modules 620 that divide what would be the joint 602 of FIG. 6A into two discrete joints 603 and 604 so that modules 620 and 610 converge at joint 603 and modules 620, 630, and 640 converge at joint 604 is provided, in accordance with various embodiments. It should be understood that only a portion of the cruciform parachute 600b is shown in FIG. 6B and the cruciform parachute 600b depicted in FIG. 6B can be constructed via joining of the component modules along the corresponding edges. Moreover, the cruciform parachute 600b is illustrated in an inflated state. Accordingly, while the module 610 is described as a square module in various embodiments, the sides of the module 610 in an inflated state may be oriented at an angle that is less than ninety degrees in the illustrated view. The joint 603 is spaced apart from joint 604. For example, joint 604 can be spaced apart from joint 604 by two inches to twenty-four inches (5.08 cm-60.96 cm) depending on the size of the parachute in which the blunted end modules are incorporated. In various embodiments, joint 604 is spaced apart from joint 603 by at least two inches (5.08 cm). In various embodiments, the two shoulder modules 620 have blunted (e.g., flat) ends 621. In various embodiments, the two shoulder modules 620 can be constructed similar to any of the modules depicted in FIGS. 7B through 7D. The blunted ends 621 can extend between and to the first joint 603 and the second joint 604. The first joint 603 and the second joint can be located at opposite edges or ends of the blunted ends 621.

In various embodiments, forming the modules 620 to have the blunted ends 621 does not alter the angle of the modules 620. In various embodiments, the blunted ends 621 of the modules 620 do not alter the angle of any of the other modules 610, 630, or 640. By forming the modules 620 to have blunted ends 621, the parachute 600b can be more easily manufactured. By forming the modules 620 to have blunted ends 621, there is less opportunity for entanglements to occur. By forming the modules 620 to have blunted ends 621, the parachute can be more easily packed.

In various embodiments, although illustrated with the modules 620 as having the blunted ends 621, the module 640 can be formed to have a blunted end. For example, one of the modules 620 and the module 640 can be formed to have blunted ends that abut one another to separate the joints 603, 604. The modules having the blunted ends can be chosen based on the configuration of the parachute and the layout of the modules.

The modules 620 can be formed as isosceles triangles (e.g., see FIG. 4A). The modules 620 can be formed as diamond-shaped modules (e.g., see FIGS. 7B-7D). The first module 620 can have a first acute angle θ1. The first module 620 can have opposing sides oriented at the first acute angle θ1. The second module 620 can have a second acute angle θ2. The second module 620 can have opposing sides oriented at the second acute angle θ2. The first acute angle θ1 and the second acute angle θ2 can be between three degrees and eighty-nine degrees in various embodiments, between five degrees and forty-five degrees in various embodiments, or between ten degrees and thirty degrees in various embodiments. The first acute angle θ1 and the second acute angle θ2 can be measured by the angle of the opposing sides of the modules 620 extending from the blunted ends 621. The first acute angle θ1 and the second acute angle θ2 can be measured at the blunted ends 621.

With reference now to FIG. 7A, a diamond-shaped module 720 is illustrated in accordance with various embodiments. The diamond-shaped module 720 can have one or more sharply pointed ends 790. The diamond-shaped module 720 can be formed by joining together two triangle modules or fabricated as a single piece. Although illustrated as a diamond-shaped module 720, it should be understood that the principles of adding additional material to a parachute module having a sharply pointed end so as to form a blunted end as described with respect to FIGS. 7B through 7D can be applied to a parachute module of any suitable shape (e.g., triangular, isosceles, etc.). For example, additional material can be similarly added to a triangular module (e.g., see the left half or the right half of the diamond-shaped module 720 of FIG. 7B). FIGS. 7B through 7D show various ways for forming a parachute module having a blunted end in accordance with various embodiments.

With reference now to FIG. 7B, one way of adding additional material to the diamond-shaped module 720 is to add a long, narrow strip of material 722 to a single side of the module 720. For example, the strip of material 722 can be added to the side 723 of the module 720. The strip of material 722 can have a flat end that forms one or more of the blunted ends 721a, 721b (referred to collectively herein as blunted ends 721) of the module 720 after the strip of material 722 is coupled to the module 720. The strip of material 722 can have a first flat end that forms the first blunted end 721a of the module 720 and a second flat end that forms the second blunted end 721b of the module 720. The strip of material 722 can extend between and to a first end of the module 720 (see the first blunted end 721a at the left end of the module 720 of FIG. 7B) and a second end of the module 720 (see the second blunted end 721b at the right end of the module 720 of FIG. 7B).

The strip of material 722 can have a uniform width W. In this manner, an outer edge 724 of the strip of material 722 can have the same shape as the side 723 to which the strip of material 722 is attached. Stated differently, the outer edge 724 can follow the contour of the side 723 of the module 720. In various embodiments, the strip of material 722 is in the shape of a parallelogram. In various embodiments, the strip of material 722 is in the shape of two parallelograms connected to one another at the center of the strip of material 722. A length L of the blunted end 721a can be equal to the width W in various embodiments. A length L of the blunted end 721b can be equal to the width W in various embodiments.

With reference now to FIG. 7C, instead of adding additional material to an outer edge of the module, additional material can be added through the center of the module 720. A strip of material 722b can be added through the center of the module 720. In this regard, the original module 720 can be split in half and a first half of the original module 720 can extend from a first side of the strip of material 722b and a second half of the original module 720 can extend from a second side of the strip of material 722b. The strip of material 722b can have a width equal to a length of the blunted ends 721a, 721b. The strip of material 722b can extend through the module 720. The strip of material 722b can have a rectangular geometry. The strip of material 722b can have a uniform width.

The strip of material 722b can have a first flat end that forms the first blunted end 721a of the module 720 (see the first blunted end 721a at the left end of the module 720 of FIG. 7C) and a second flat end that forms the second blunted end 721b of the module (see the second blunted end 721b at the right end of the module 720 of FIG. 7C). The strip of material 722b can extend between and to a first end of the module 720 (see the first blunted end 721a at the left end of the module 720 of FIG. 7C) and a second end of the module 720 (see the second blunted end 721b at the right end of the module 720 of FIG. 7C).

With reference now to FIG. 7D, the additional material can be added to one or more outer edges 723 of the module 720 in addition to being added through the center of the module 720. In this regard, the designs of FIG. 7B and FIG. 7C can be combined, for example as illustrated in FIG. 7D. A first strip of material 722c can be added through the center of the module 720. A second strip of material 722d can be added to a first side 723b of the module 720. A third strip of material 722e can be added to a second side 723c of the module 720. In this regard, the original module 720 can be split in half and a first half of the original module 720 can extend from a first side of the strip of material 722c and a second half of the original module 720 can extend from a second side of the strip of material 722c. The strip of material 722b can have a width that is less than a length of the blunted end 721a. The width of the strip of material 722b can be one third the total length of the blunted end 721a in various embodiments, one half the total length of the blunted end 721a in various embodiments, or two thirds the total length of the blunted end 721a in various embodiments. The strip of material 722c can extend through the module 720. The strip of material 722c can have a rectangular geometry. The strip of material 722c can have a uniform width.

The strip of material 722d can be similar to the strip of material 722 of FIG. 7B, except the strip of material 722d has a width which is less than the width W of the strip of material 722. The width of the strip of material 722d can be equal to the width of the strip of material 722c. The width of the strip of material 722d can be equal to the width of the strip of material 722e. The width of the strip of material 722d can be half of the width of the strip of material 722c. The width of the strip of material 722d can be half of the width of the strip of material 722c. The width of the strip of material 722d can be double the width of the strip of material 722c. The total sum of the widths of the strips of material 722c, 722d, and 722e can be equal to the length L (i.e., W1+W2+W3=L).

The strip of material 722e can be similar to the strip of material 722 of FIG. 7B, except the strip of material 722e has a width which is less than the width W of the strip of material 722 and the strip of material 722e is located on an opposite side of the module 720 from the strip of material 722d. The strip of material 722e can be arranged as a mirror image of the strip of material 722d.

In various embodiments, the strips of material 722c, 722d, and 722e converge at the blunted ends 721.

It should be understood that a strip of material can be added to an existing module to modify the existing module to have a blunted end. Stated differently, the strip of material can be made as a separate piece of material from the module. In various embodiments, the module and the strip of material are formed from a single sheet of material. In this regard, the strip of material can be retrofitted into an existing module or can be formed together with the module at the time the module is manufactured. A blunted module (e.g., a shoulder module) as described herein in various embodiments can be flat (i.e., two-dimensional).

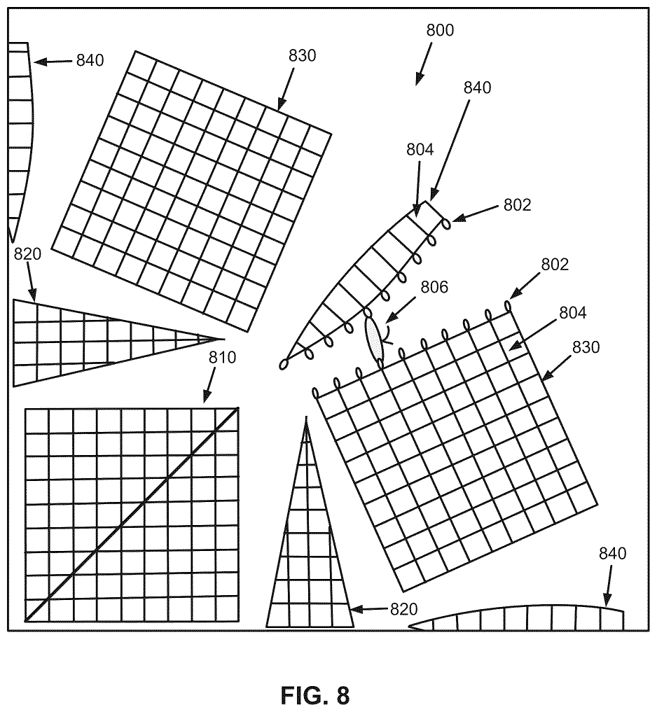

Any of the parachute canopies described herein can be sewn solidly together, can be sewn together at discrete points, or can be tied together at discrete points. FIG. 8 provides an example cruciform parachute with modules that are tied together at discrete points, in accordance with various embodiments.

Turning now to FIG. 8, in various exemplary embodiments a cruciform parachute 800 is configured with a center module 810, side modules 830, corner modules 840, and with a plurality of shoulder modules 820. Only a quarter of the cruciform parachute 800 is shown in the illustrated embodiment to provide an enlarged view of connections 802 between corner module 840 and side module 830, in accordance with various embodiments. Although described with respect to corner module 840 and side module 830, it should be understood that any of the modules described herein can be joined together via the connections 802.

In the illustrated embodiment, each black line 804 represents a reinforcement webbing. Each reinforcement webbing 804 can terminate with a connection 802. Each connection 802 can be an open loop. Theses loops can then be tied together with a cordage tie 806. Only one cordage tie 806 is shown for ease of illustration. However, it should be understood that each connection 802 can be coupled to a cordage tie 806. In this regard, immediately adjacent sides of the modules can have an equal number of connections 802 that are configured to be coupled together via a cordage tie 806.

Having the connections 802 at discrete points tends to promote airflow through the canopy, which tends to mitigate pendulum type oscillations of a parachute system, particularly when only one or two parachutes are utilized. If only one parachute is used, a random direction oscillation tends to develop for a typical parachute. If two parachutes are utilized, a fore and aft oscillation tends to develop, much like the action of a playground swing.

MSC (modular semispherical cruciform) type parachutes, such as cruciform parachute 800, having canopy modules that are tied together at discrete points allow for ease of repair. For example, rather than sending the entire parachute to a repair shop, where users may have to wait weeks or months for its return, a user can simply cut the cordage ties that secure the damaged module to its adjoining modules and then tie-in a replacement module, allowing the parachute to stay in service. This can be particularly beneficial for various fields of use such as for the military for example.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

In the foregoing specification, inventive concepts have been described with reference to various embodiments. However, one of ordinary skill in the art appreciates that various modifications and changes can be made without departing from the scope of the inventive concepts as set forth in the claims below. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A cruciform parachute, comprising:
a first module having a first blunted end;
a second module having a second blunted end coupled to the first blunted end;
a first joint located at a first end of the first blunted end;
a second joint located at a second end of the first blunted end;
a third module having a first pointed end that converges at the first joint; and
a fourth module having a second pointed end that converges at the second joint.

2. The cruciform parachute of claim 1, wherein the first module is coupled to the third module along a first side of the first module.

3. The cruciform parachute of claim 2, wherein the first module is coupled to the fourth module along a second side of the first module.

4. The cruciform parachute of claim 3, wherein the third module is a square center module.

5. The cruciform parachute of claim 4, wherein the first module is a first shoulder module.

6. The cruciform parachute of claim 5, wherein the second module is a second shoulder module.

7. The cruciform parachute of claim 6, wherein the fourth module is a first square side module.

8. The cruciform parachute of claim 7, further comprising a fifth module having a third pointed end that converges at the second joint.

9. The cruciform parachute of claim 8, wherein the fifth module is a second square side module.

10. The cruciform parachute of claim 9, further comprising a sixth module having a fourth pointed end that converges at the second joint.

11. The cruciform parachute of claim 10, wherein the sixth module is a corner module located between the fourth module and the fifth module.

12. The cruciform parachute of claim 3, wherein the first module comprises first opposing sides oriented at a first acute angle.

13. The cruciform parachute of claim 12, wherein the second module comprises second opposing sides oriented at a second acute angle.

14. The cruciform parachute of claim 1, further comprising a strip of material extending from a first side of the first module and at least partially defining the first blunted end and a second blunted end of the first module, the strip of material extends between and to the first blunted end of the first module and the second blunted end of the first module.

15. The cruciform parachute of claim 1, further comprising a strip of material extending through a center of the first module and defining the first blunted end and a second blunted end of the first module, the strip of material extends between and to the first blunted end of the first module and the second blunted end of the first module.

16. A cruciform parachute, comprising:
a square center module;
a first square side module, the first square side module having similar dimensions to the square center module;
a second square side module, the second square side module having similar dimensions to the square center module;
a first shoulder module coupled to the first square side module and to the square center module, the first shoulder module having a first blunted end;
a second shoulder module coupled to the second square side module and to the square center module, the second shoulder module having a second blunted end extending along the first blunted end;
the square center module converges at a first joint defined by a first end of the first blunted end;
the first square side module converges at a second joint defined by a second end of the first blunted end; and
the second square side module converges at the second joint.

17. The cruciform parachute of claim 16, wherein the first shoulder module is coupled to the square center module along a first side of the first shoulder module and the first shoulder module is coupled to the first square side module along a second side of the first shoulder module.

18. The cruciform parachute of claim 16, wherein at least one of the first shoulder module or the second shoulder module is configured in the shape of an isosceles triangle.

19. A cruciform parachute, comprising:
a first plurality of modules converging at a first joint;
a second plurality of modules converging at a second joint, the first and second joints are spaced apart from one another;
the first plurality of modules includes a first module having a first blunted end;
the first plurality of modules includes a second module having a second blunted end extending along the first blunted end; and
the first blunted end and the second blunted end extend between and to the first joint and the second joint.

20. The cruciform parachute of claim 19, wherein the first plurality of modules includes a third module, and the first module is coupled to the third module along a first side of the first module.
